(19) United States
(12) Patent Application Publication
(10) Pub. No.: US 2014/0370357 A1
(43) Pub. Date: Dec. 18, 2014

(54) BATTERY CELL, BATTERY UNIT AND BATTERY STACK

(71) Applicant: TOYODA GOSEI CO., LTD., Kiyosu-shi (JP)

(72) Inventors: Yoshiaki TATSUMI, Kiyosu-shi (JP); Takaaki YOKOI, Kiyosu-shi (JP); Yasunori UCHIDA, Kiyosu-shi (JP); Junta KATAYAMA, Miyoshi-shi (JP)

(21) Appl. No.: 14/306,414

(22) Filed: Jun. 17, 2014

(30) Foreign Application Priority Data
Jun. 18, 2013 (JP) 2013-127432

(51) Int. Cl. H01M 2/02; H01M 2/20

(52) U.S. Cl. CPC H01M 2/0245; H01M 2/206; H01M 2220/20; H01M 2200/00
USPC 429/121; 429/179

(57) ABSTRACT

Rectangular battery cells 30A and 30B are used for the battery stack 10. Each of the battery cells 30A and 30B includes: a batter casing 32 having: a reference surface 32a defined by a first direction and a second direction orthogonal to each other; and a terminal support surface 32b extended from an end of the reference surface 32a toward a third direction orthogonal to both the first direction and the second direction; and a positive electrode terminal 34p and a negative electrode terminal 34n protruded from the terminal support surface 32b and arranged at a predetermined distance from each other in the first direction. The positive electrode terminal 34p and the negative electrode terminal 34n are located at positions of different distances in the first direction from the center of the terminal support surface 32b.

### CROSS-REFERENCE To RELATED APPLICATIONS

The present application claims the priority based on Japanese Patent Application No. 2013-127432 filed on Jun. 18, 2013, the disclosure of which is hereby incorporated by reference in its entirety.

### BACKGROUND

1. Technical Field

The present invention relates to a battery cell, a battery unit and a battery stack.

2. Related Art

A technique disclosed in Japanese Patent No. 5159112 has been known with regard to a battery stack. FIG. 11 is a top view of a battery stack 100, and FIG. 12 is a view from the direction of an arrow AR in FIG. 12. With referring to FIGS. 11 and 12, the battery stack 100 is formed by successively stacking battery cells 102 and 112 of different structures. More specifically, the battery cell 102 has a positive electrode terminal 104p and a negative electrode terminal 104n on an end face of a casing. The positive electrode terminal 104p and the negative electrode terminal 104n are both formed in an L shape which protrudes upward (in the illustration) and is bent in the horizontal direction. The battery cell 112, on the other hand, has a positive electrode terminal 114p and a negative electrode terminal 114n on an end face of a casing. The positive electrode terminal 114p and the negative electrode terminal 114n are also formed in an L shape which protrudes upward (in the illustration) and is bent in the horizontal direction. The positive electrode terminal 114p of the battery cell 112 is bent in an opposite direction to the bent direction of the positive electrode terminal 104p of the battery cell 102. The negative electrode terminal 114n of the battery cell 112 is bent in an opposite direction to the bent direction of the negative electrode terminal 104n of the battery cell 102. An overlapped part where the negative electrode terminal 104n of the battery cell 102 overlaps the positive electrode terminal 114p of the battery cell 112 is fastened by a bolt 120. This causes the battery cell 102 and the battery cell 112 to be connected both electrically and mechanically.

### SUMMARY

The battery cell 102 and the battery cell 112 in this prior art battery stack 100 have the positive electrode terminals 104p and 114p bent in the different directions and the negative electrode terminals 104n and 114n bent in the different directions. This prior art battery stack 100 uses two different types of battery cells 102 and 112 having positive electrode terminals and negative electrode terminals in different configurations. There is accordingly a need to alternately arrange these two different types of battery cells to overlap each other. Such work is troublesome and is likely to cause wrong connection.

In order to address at least part of the problems described above, the invention may be implemented by the following aspects.

According to one aspect of the invention, there is provided a rectangular battery cell. The battery cell comprises: a battery casing having: a reference surface defined by a first direction and a second direction orthogonal to each other; and a terminal support surface extended from an end of the reference surface toward a third direction which is orthogonal to both the first direction and the second direction; and a positive electrode terminal and a negative electrode terminal protruded from the terminal support surface and arranged at a predetermined distance from each other in the first direction. The positive electrode terminal and the negative electrode terminal are located at positions of different distances in the first direction from a center of the terminal support surface. The configuration of this aspect enables a plurality of battery cells of the same structure to be directly connected with one another. This configuration is unlikely to cause wrong wiring, compared with the configuration of alternately arranging battery cells of different structures as described in the prior art.

### BRIEF DESCRIPTION OF DRAWINGS

FIG. 1 is a perspective view illustrating a battery stack in which a plurality of battery cells are held, according to one embodiment of the invention;

FIG. 2 is a plan view illustrating the battery stack of FIG. 1;

FIG. 3 is a perspective view illustrating a battery unit;

FIG. 4 is a plan view illustrating the battery unit;

FIG. 5 is a side view of the battery unit;

FIG. 6 is an exploded perspective view of the battery unit;

FIG. 7 is an explanatory diagram illustrating an assembling process of the battery unit;

FIG. 8 is an explanatory diagram illustrating the assembling process subsequent to FIG. 7;

FIG. 9 is an explanatory diagram illustrating the assembling process subsequent to FIG. 8;

FIG. 10 is an explanatory diagram illustrating electrical connection paths of the battery unit;

FIG. 11 is a top view of a prior art battery stack; and

FIG. 12 is a view from the direction of an arrow AR in FIG. 11.

### DESCRIPTION OF THE PREFERRED EMBODIMENT

### (1) General Structure of Battery Stack

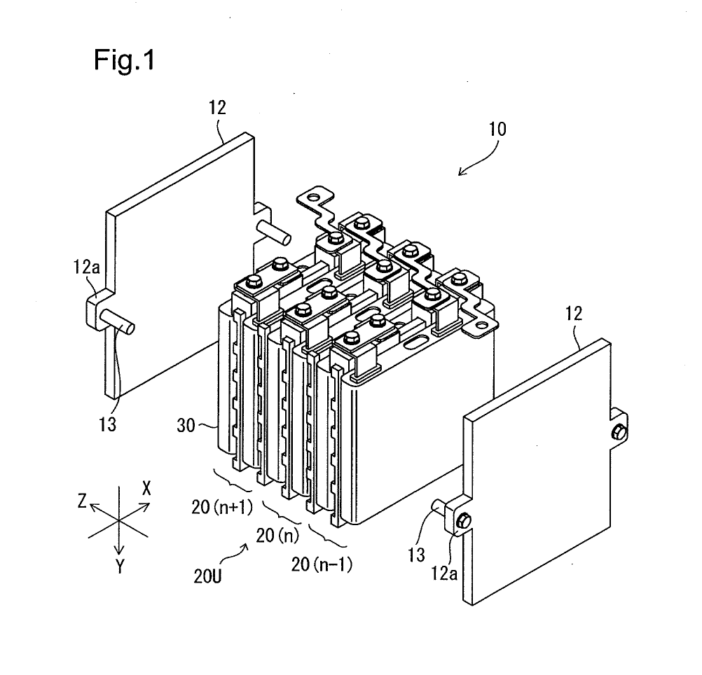

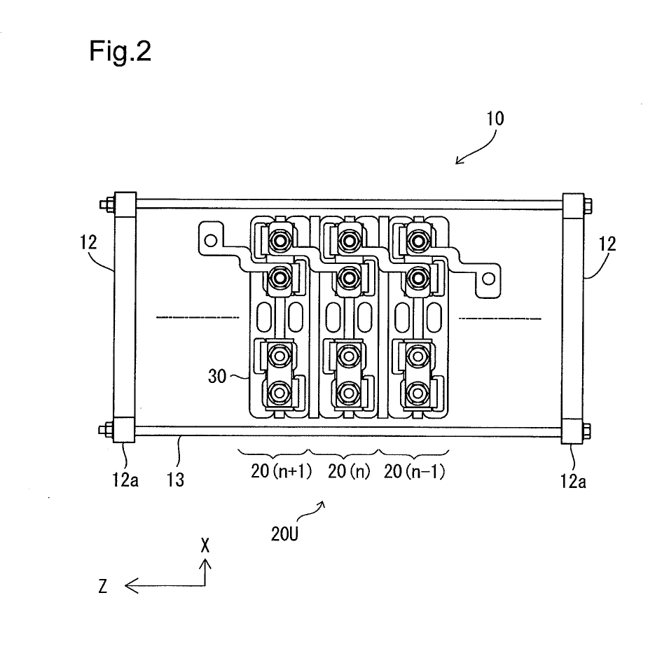

FIG. 1 is a perspective view illustrating a battery stack 10 in which a plurality of battery cells are held, according to one embodiment of the invention. FIG. 2 is a plan view illustrating the battery stack of FIG. 1. The battery stack 10 is formed by stacking a plurality of battery units 20, each being comprised of two battery cells. The battery cell 30 is a flat rectangular general-purpose battery and may be, for example, a lithium ion battery used as the power source for automobiles.

XYZ axes orthogonal to one another are illustrated in FIG. 1. With regard to the relationship to the invention, the X-axis direction corresponds to the first direction; the Y-axis direction corresponds to the second direction; and the Z-axis direction corresponds to the third direction. The battery units 20 are arrayed in the Z-axis direction. Each specific one of the battery units 20 arrayed in the Z-axis direction or its component member is expressed by adding an index such as (n−1), (n), (n+1), . . .

The battery stack 10 includes a unit assembly 20U by assembling the plurality of battery units 20, and support plates 12 located on respective sides of the unit assembly 20U. Mounting parts 12a are formed on both sides of the support plate 12. The plurality of battery units 20 are integrally assembled by connecting the support plates 12 on the respective sides with each other via joint members 13 at the positions of the mounting parts 12a.

### (2) Structures of Respective Components of Battery Stack 10

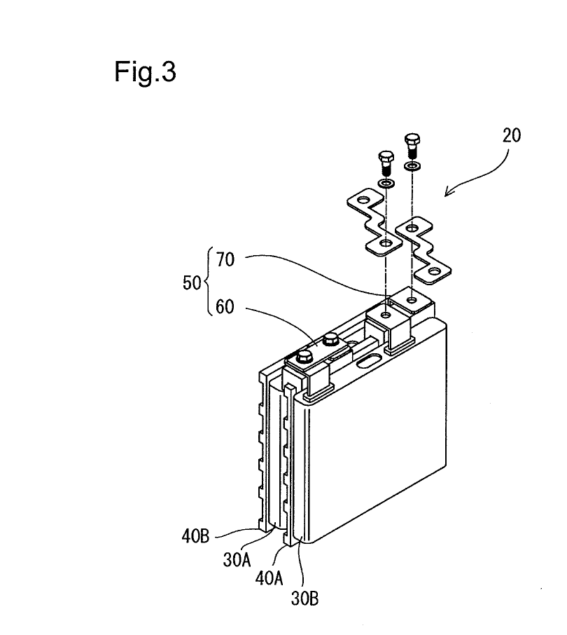

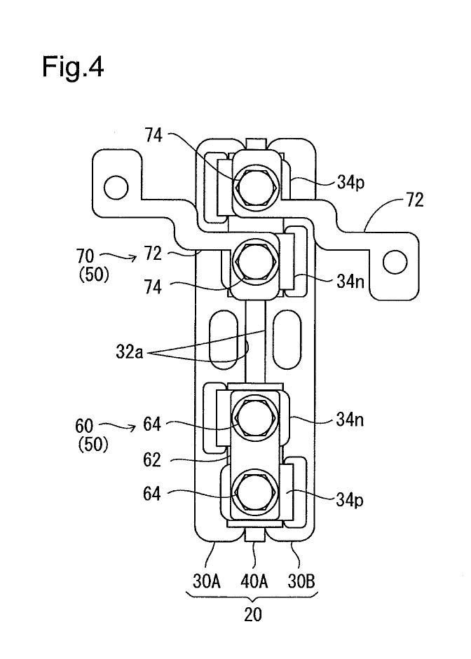

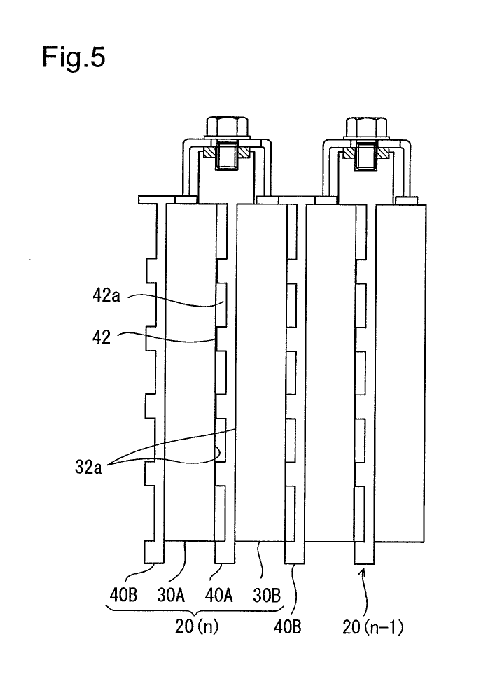

FIG. 3 is a perspective view illustrating the battery unit 20. FIG. 4 is a plan view illustrating the battery unit 20. FIG. 5 is a side view illustrating the two battery units 20. The battery unit 20 includes two battery cells 30A and 3013, a first insulating member 40A, a second insulating member 40B and a coupling fixation mechanism 50.

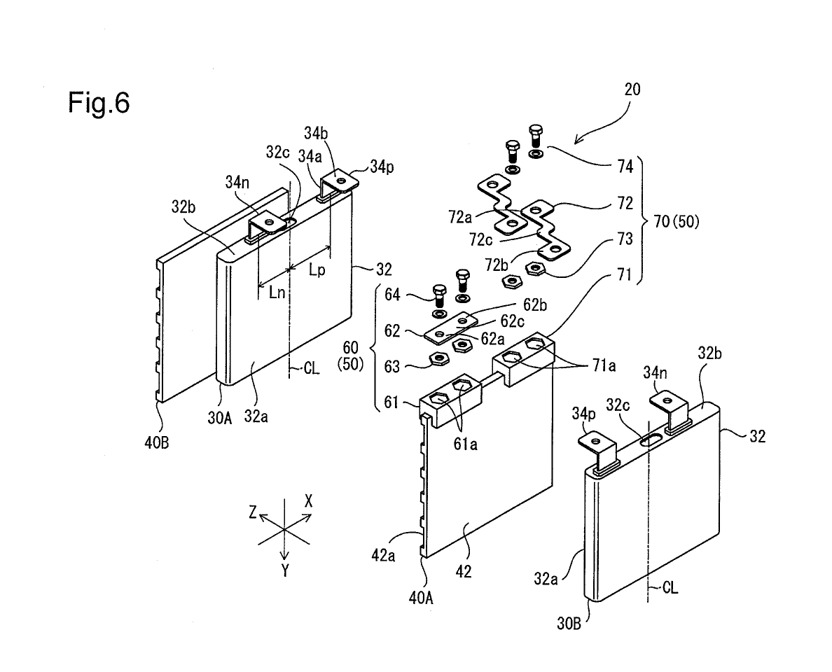

FIG. 6 is an exploded perspective view of the battery unit 20. With referring to FIG. 6, the battery unit 20 includes two battery cells 30A and 30B. The battery cells 30A and 30B are cells of the same structure and are arranged such that one battery cell 30B is turned by 180 degrees relative to the other battery cell 30A. Each of the battery cells 30A and 30B has a battery casing 32. The battery casing 32 is made of a metal material such as aluminum or iron to block the water vapor penetrating from outside to inside of the battery casing 32.

The battery casing 32 is in a flat rectangular shape surrounded by side faces and end faces. The rectangular shape of the battery casing 32 herein includes a rectangular parallelepiped shape having chamfered edges in addition to the exact rectangular parallelepiped shape, and may be any shape having substantially the same width for stacking. One of the side faces of the battery casing 32 forms a reference surface 32a defined by the X-axis direction and the Y-axis direction orthogonal to each other. The two battery cells 30A and 30B are arranged such that the respective reference surfaces 32a are opposed to each other. One of the end faces of the battery casing 32 forms a terminal support surface 32b extended from the upper end of the reference surface 32a toward the Z-axis direction. A positive electrode terminal 34p and a negative electrode terminal 34n are formed on the terminal support surface 32b.

The positive electrode terminal 34p and the negative electrode terminal 34n are formed in the same L shape which includes a base 34a protruded in the Y-axis direction from the terminal support surface 32b and a connection element 34b bent from an upper end of the base 34a in the Z-axis direction. As shown in connection with the battery cell 30A, the positive electrode terminal 34p and the negative electrode terminal 34n are respectively located at different distances Lp and (Lp>Ln) in the X-axis direction from a center axis CL of the terminal support surface 32b. The center axis CL of the terminal support surface 32b may be the axis which goes through the median point (i.e. the center) of the terminal support surface 32b, is parallel to the reference surface 32a, and is perpendicular to the stacking direction of the battery casing 32 (the Z-axis direction in this embodiment). Herein Lp and Ln respectively represent distances from the center axis CL to the center of the positive electrode terminal 34p and to the center of the negative electrode terminal 34n. The positive electrode terminals 34p and the negative electrode terminals 34n of the battery cells 30A and 30B are arranged not to overlap each other in the configuration that the respective reference surfaces 32a of the battery cells 30A and 30B are opposed to each other by turning the battery cell 30B about the center axis CL by 180 degrees (FIG. 4). A vent hole 32c is formed in the center area of the terminal support face 32b to release the gas produced in the battery cell 30A or 30B.

With referring to FIG. 5, the first insulating member 40A is placed between the battery cell 30A and the battery cell 30B. More specifically, the first insulating member 40A is located between the reference surface 32a of the battery cell 30A and the reference surface 32a of the battery cell 30B. The first insulating member 40A has an insulating plate 42 in substantially the same shape as the side face of the battery unit 20 in which insulation between the battery cells 30A and 30B is provide. A plurality of cooling paths 42a are formed on the side face of the insulating plate 42 to cool down the battery cells 30A and 30B. The cooling paths 42a are formed parallel to the Y-axis direction (FIG. 6). The first insulating member 40A may he made of, for example, polypropylene (PP) or polybutylene terephthalate (PBT). The second insulating member 40B is placed between the adjacent battery units 20 and has the same configuration as that of the first insulating member 40A.

With referring to FIG. 6, the coupling fixation mechanism 50 includes an inner connecting mechanism 60 and an outer connecting mechanism 70. The inner connecting mechanism 60 is provided as a mechanism to electrically connect and mechanically couple the battery cell 30A with the battery cell 30B in the battery unit 20. The inner connecting mechanism 60 includes as fixation element 61, an inner connecting plate 62, nuts 63 and fastening members 64. The fixation element 61 is a member to support the inner connecting plate 62 and is formed integrally with the upper end of the insulating plate 42. Two attachment holes 61a are arranged along the X-axis direction on the upper surface of the fixation element 61. Each of the attachment holes 61a is formed in the Y-axis direction and is formed in a hexagonal shape to allow the nut 63 to be fit in and attached to and lock the nut 63. The hole of the nut 63 is threaded to be fastened by the fastening member 64. The inner connecting plate 62 is a long metal plate member and has a first connecting part 62a and a second connecting part 62b, which are linked with each other and are integrated by a linkage part 62c. Through holes are formed respectively in the first connecting part 62a and in the second connecting part 62b. The connecting process using the inner connecting mechanism 60 will be described later.

The outer connecting mechanism 70 is provided as a mechanism to electrically connect and mechanically couple the adjacent battery units 20(n−1), 20(n), . . . with one another (FIGS. 1 and 2). The outer coupling mechanism 70 includes a fixation element 71, an outer connecting plate 72, nuts 73 and fastening members 74 in the form of bolts. The fixation element 71 is a member to support the outer connecting plate 72 and is formed integrally with the upper end of the insulating plate 42. Two attachment holes 71a are arranged along the X-axis direction on the upper surface of the fixation element 71. Each of the attachment holes 71a is formed in the Y-axis direction and is formed in a hexagonal shape to allow the nut 73 to be fit in and attached to and lock the nut 73. The hole of the nut 73 is threaded to be fastened by the fastening member 74. The outer connecting plate 72 is a metal plate member and has a first connecting part 72a and a second connecting part 72b, which are linked with each other by a linkage part 72c. Through holes are formed respectively in the first connecting part 72a and in the second connecting part 72b, The connecting process using the outer connecting mechanism 70 will be described later.

### (3) Assembling Process of Battery Unit 20 and Battery Stack 10

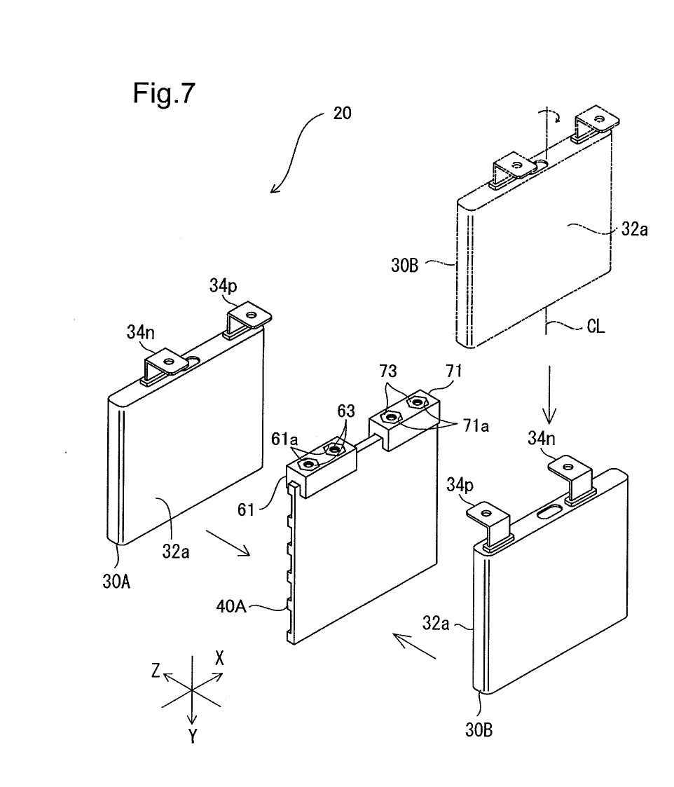

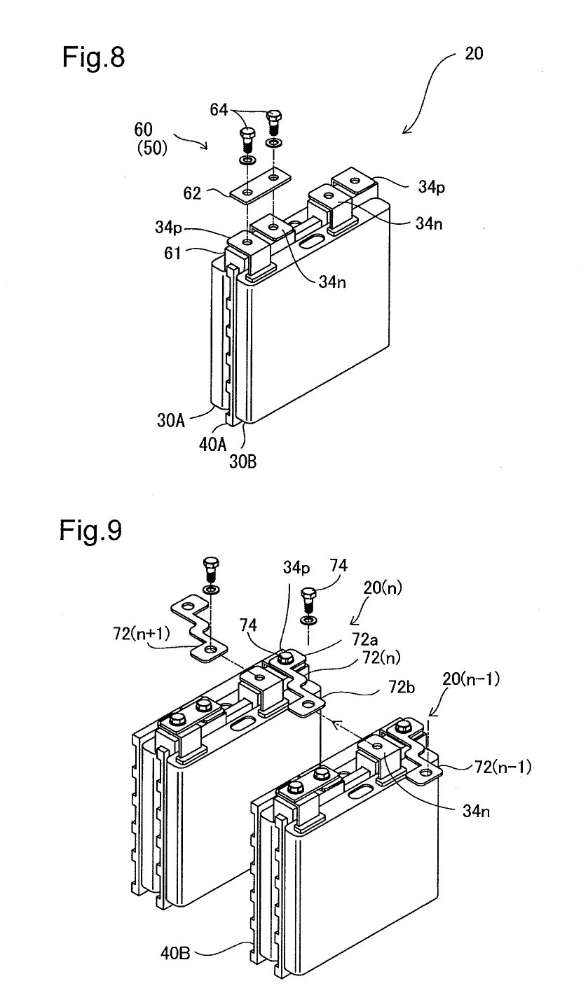

FIGS. 7 and 8 are explanatory diagrams illustrating an assembling process of the battery unit 20, With referring to FIG. 7, the process respectively sets the nuts 63 in the attachment holes 61a of the fixation element 61 and sets the nuts 73 in the attachment holes 71a of the fixation element 71 on the upper portion of the first insulating member 40A. The process subsequently adjusts the reference surface 32a of the battery cell 30A to one side face of the first insulating member 40A. The process then turns the battery cell 30B about the center axis CL by 180 degrees relative to the battery cell 30A and adjusts the reference surface 32a of the battery cell 30B to the other side face of the first insulating member 40A (the state of FIG. 8). The process subsequently mounts the inner connecting plate 62 on the negative electrode terminal 34n of the battery cell 30A and the positive electrode terminal 34p of the battery cell 30B as shown in FIG. 8. The process fastens the inner connecting plate 62 with the fastening members 64, so as to fix the inner connecting plate 62 to the fixation element 61 and electrically connect the negative electrode terminal 34n of the battery cell 30A with the positive electrode terminal 34p of the battery cell 30B (the state of FIG. 9). This integrates the battery unit 20.

The following describes the process of assembling the plurality of battery units 20 in connection with an example of assembling two battery units 20(n−1) and 20(n) with reference to FIG. 9. The process places the second insulating member 40B between the plurality of pre-assembled battery units 20(n−1) and 20(n) and adjusts the battery units 20(n−1) and 20(n) to each other. The process subsequently mounts the first connecting part 72a of the outer connecting plate 72(n) on the positive electrode terminal 34p of the battery unit 20(n) and also mounts the second connecting part 72b of the outer connecting plate 72(n) on the negative electrode terminal 34n of the battery unit 20(n−1). In this state, the outer connecting plate 72(n) is fastened by the fastening members 74. This causes the battery units 20(n−1) and 20(n) to be electrically connected with each other and simultaneously coupled with each other mechanically. In this manner, the positive electrode terminals 34p and the negative electrode terminals 34n of the adjacent battery units 20 are sequentially connected by the outer connecting plates 72. This completes the battery stack 10 shown in FIGS. 1 and 2.

### (4) Electrical Connection Path of Battery Unit 20

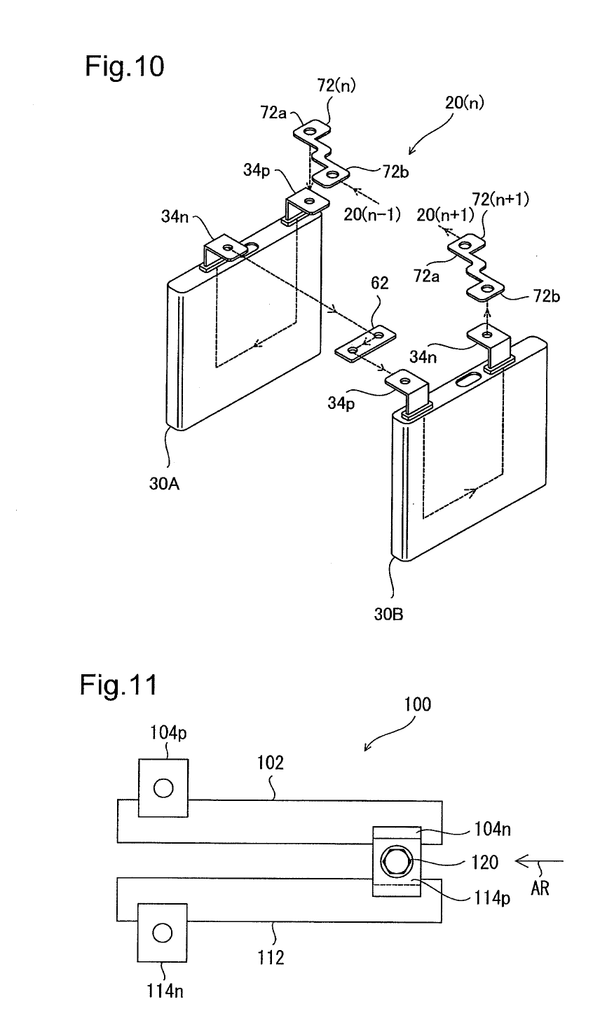

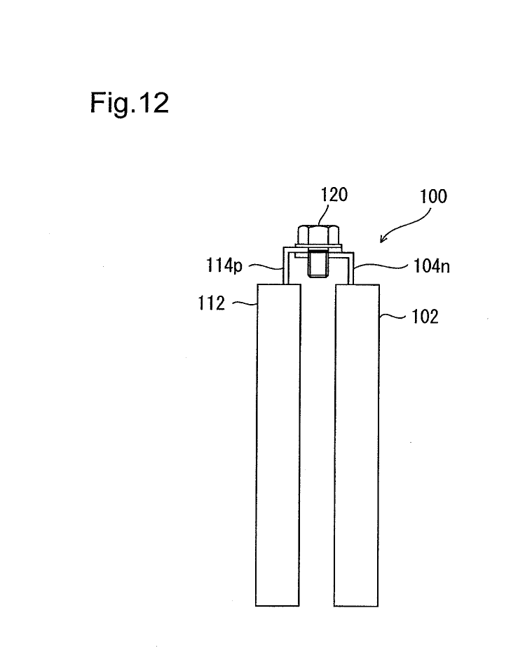

FIG. 10 is an explanatory diagram illustrating electrical connection paths of the battery unit 20. With referring to FIG. 10, the following describes the electrical connection paths of the battery unit 20(n) with the battery unit 20(n−1) and with the battery unit 20(n+1). FIG. 10 shows only the main part of the electrical connection paths of the battery unit 20(n), with omission of part of the members. The outer connecting plate 72(n) linked with the negative electrode terminal 34n of the battery unit 20(n−1) is also linked at its first connecting part 72a with the positive electrode terminal 34p of the battery cell 30A in the battery unit 20(n). The positive electrode terminal 34p is connected with the inner connecting plate 62 through the internal path of the battery cell 30A and the negative electrode terminal 34n of the battery cell 30A. The inner connecting plate 62 is further connected with the second connecting part 72b of the outer connecting plate 72(n+1) through the positive electrode terminal 34p of the battery cell 30B, the internal pathway of the battery cell 30B and the negative electrode terminal 34n of the battery cell 30B. The first connecting part 72a of the outer connecting plate 72(n+1) is further connected with the positive electrode terminal 34p of the adjacent battery unit 20(n+1). In this manner, the respective battery cells 30A and 30B of each battery unit 20 are connected in series via the inner connecting plate 62. The plurality of battery units 20 are then connected in series via the outer connecting plates 72.

### (5) Functions and Advantageous Effects of Battery Stack 10

(5)-1

As shown in FIGS. 1, 7 and 8, the battery unit 20 is assembled from the battery cells 30A and 30B of the same structure by turning one battery cell 30B by 180 degrees relative to the other battery cell 30A, such that the reference surfaces 32a of the respective battery casings 32 of the battery cells 30A and 30B are opposed to each other, and integrating the battery cells 30A and 30B by the inner connecting mechanism 60. This causes the two battery cells 30A and 30B to be electrically connected and mechanically coupled with each other, thus simplifying the assembling process. The configuration of using the battery cells 30A and 30B of the same structure is unlikely to cause wrong wiring, compared with the configuration alternately arranging the batteries of different structures as described in connection with the prior art.

(5)-2

As shown in FIG. 6, the positive electrode terminal 34p and the negative electrode terminal 34n of the battery cell 30 are placed at different positions on the terminal support surface 32b of the battery casing 32. More specifically, the positive electrode terminal 34p is located at the distance Lp from the center of the terminal support surface 32b, whereas the negative electrode terminal 34n is located at the distance Ln (Lp>Ln) from the center of the terminal support surface 32b. This facilitates identification between the positive electrode terminal 34p and the negative electrode terminal 34n of the battery cell 30 and is unlikely to cause wrong wiring.

(5)-3

As shown in FIG. 9, the assembling process of the plurality of battery units 20 stacks the plurality of battery units 20 in the same orientation and integrates the plurality of battery units 20 by the outer connecting mechanism 70. This causes the adjacent battery units 20 to be electrically connected and mechanically coupled with each other, thus simplifying the assembling process. Additionally, using the battery units 20 of the same structure is unlikely to cause wrong wiring.

The invention is not limited to the above embodiment, examples or modifications, but a diversity of variations and modifications may be made to the embodiments without departing from the scope of the invention. In the embodiment described above, the fixation element 61 of the inner connecting mechanism 60 and the fixation element 71 of the outer connecting mechanism 70 are formed integrally with the insulating member 40. Alternatively the fixation element 61 and the fixation element 71 may be provided as separate members from the insulating member 40 which are enabled to position the inner connecting plate 62 and the outer connecting plate 72.

In the embodiment described above, the cooling paths 42a of the insulating member 40 are configured as the air cooling paths. This is, however, not restrictive, but the cooling paths 42a may be configured to make the flow of a cooling medium such as liquid refrigerant. The cooling paths 42a may be formed on both surfaces of the insulating plate 42, instead of being formed on only one surface of the insulating plate 42 described in the above embodiment.

(5)-4

According to one aspect of the invention, there is provided a rectangular battery cell. The battery cell comprises: a battery casing baying: a reference surface defined by a first direction and a second direction orthogonal to each other; and a terminal support surface extended from an end of the reference surface toward a third direction which is orthogonal to both the first direction and the second direction; and a positive electrode terminal and a negative electrode terminal protruded from the terminal support surface and arranged at a predetermined distance from each other in the first direction. The positive electrode terminal and the negative electrode terminal are located at positions of different distances in the first direction from a center of the terminal support surface. The configuration of this aspect enables a plurality of battery cells of the same structure to be directly connected with one another. This configuration is unlikely to cause wrong wiring, compared with the configuration of alternately arranging battery cells of different structures as described in the prior art.

In one embodiment of the battery cell, the positive electrode terminal and the negative electrode terminal may include: bases protruded in the second direction from the terminal support surface; and connection elements extending from respective one ends of the bases in a same direction along the third direction.

According to another aspect of the invention, there is provided a battery unit using a plurality of the battery cells described above, wherein a pair of the battery cells are arranged such that the reference surface of one battery cell is opposed to the reference surface of the other battery cell, and the positive electrode terminal of the one battery cell and the negative electrode terminal of the other battery cell do not to overlap each other, wherein the positive electrode terminal of the one battery cell and the negative electrode terminal of the other battery cell are connected with each other via an inner connecting plate disposed in the first direction. This causes the two battery cells to be electrically connected and mechanically coupled with each other, thus simplifying the assembling process.

According to another embodiment of the invention, the battery unit may further comprise fastening members configured to fasten the positive electrode terminal to the inner connecting plate and to fasten the negative electrode terminal to the inner connecting plate.

According to another embodiment of the invention, the battery unit may further comprise: an insulating member located between the reference surface of the one battery cell and the reference surface of the other battery cell; and a fixation element attached to an upper portion of the insulating member to fix the inner connecting plate. In this embodiment, the insulating member enhances the insulation properties between the battery cells of the battery unit and securely supports the inner connecting plate to connect the positive electrode terminal with the negative electrode terminal.

According to another aspect of the invention, there is provided a battery stack comprising the battery unit described above. The battery stack comprises: a unit assembly including a plurality of the battery unit stacked in the third direction; and an outer connecting plate configured to connect (i) the positive electrode terminal of one battery unit which is not connected by the inner connecting plate and (ii) the negative electrode terminal of the other battery unit which is not connected by the inner connecting plate. In this aspect, the battery stack is assembled by assembling the plurality of stacked battery units. The unit assembly is formed by stacking the plurality of battery units in the third direction. The positive electrode terminal and the negative electrode terminal of the adjacent battery units which are not connected by the inner connecting plate are coupled with each other, among the positive electrode terminals and the negative electrode terminals of the adjacent battery units. This completes the battery stack. This integrally assembles the plurality of battery units and electrically connects the positive electrode and the negative electrode of each battery unit, thus simultaneously achieving the mechanical linkage of the battery units.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A rectangular battery cell, comprising:
a battery casing having: a reference surface defined by a first direction and a second direction orthogonal to each other; and a terminal support surface extended from an end of the reference surface toward a third direction which is orthogonal to both the first direction and the second direction; and
a positive electrode terminal and a negative electrode terminal protruded from the terminal support surface and arranged at a predetermined distance from each other in the first direction, wherein
the positive electrode terminal and the negative electrode terminal are located at positions of different distances in the first direction from a center of the terminal support surface.

2. The battery cell according to claim 1, wherein
the positive electrode terminal and the negative electrode terminal include;
bases protruded in the second direction from the terminal support surface; and
connection elements extending from respective one ends of the bases in a same direction along the third direction.

3. A battery unit using a plurality of the battery cell according to claim 1, wherein
a pair of the battery cells are arranged such that the reference surface of one battery cell is opposed to the reference surface of the other battery cell, and the positive electrode terminal of the one battery cell and the negative electrode terminal of the other battery cell do not to overlap each other, wherein
the positive electrode terminal of the one battery cell and the negative electrode terminal of the other battery cell are connected with each other via an inner connecting plate disposed in the first direction.

4. The battery unit according to claim 3, further comprising:
fastening members configured to fasten the positive electrode terminal to the inner connecting plate and to fasten the negative electrode terminal to the inner connecting plate.

5. The battery unit according to claim 3, further comprising:
an insulating member located between the reference surface of the one battery cell and the reference surface of the other battery cell; and
a fixation element attached to an upper portion of the insulating member to fix the inner connecting plate.

6. A battery stack comprising the battery unit according to claim 3, comprising:
a unit assembly including a plurality of the battery unit stacked in the third direction; and
an outer connecting plate configured to connect (i) the positive electrode terminal of one battery unit which is not connected by the inner connecting plate and (ii) the negative electrode terminal of the other battery unit which is not connected by the inner connecting plate.
